(19) United States
(12) Patent Application Publication
(10) Pub. No.: US 2022/0416249 A1
(43) Pub. Date: Dec. 29, 2022

(54) SECONDARY BATTERY

(71) Applicant: MURATA MANUFACTURING CO., LTD., Kyoto (JP)

(72) Inventors: Yuta HIRANO, Kyoto (JP); Takaaki MATSUI, Kyoto (JP); Masaaki ITOU, Kyoto (JP)

(21) Appl. No.: 17/895,322

(22) Filed: Aug. 25, 2022

Related U.S. Application Data
(63) Continuation of application No. PCT/JP2021/003487, filed on Feb. 1, 2021.

(30) Foreign Application Priority Data
Feb. 26, 2020 (JP) 2020-030308

(51) Int. Cl. H01M 4/62; H01M 10/0525; H01M 4/525; H01M 4/587; H01M 4/36

(52) U.S. Cl. CPC H01M 4/623; H01M 10/0525; H01M 4/625; H01M 4/525; H01M 4/587; H01M 4/364; H01M 2004/021

(57) ABSTRACT

A secondary battery includes a positive electrode, a negative electrode, and an electrolytic solution. The positive electrode includes a positive electrode active material layer. The positive electrode active material layer includes a positive electrode active material, a positive electrode binder, and a positive electrode conductor. The negative electrode includes a negative electrode active material. The positive electrode active material includes a lithium-cobalt composite oxide. The positive electrode binder includes a vinylidene fluoride polymer having a melting point of higher than or equal to 160° C. and lower than or equal to 170° C. The positive electrode conductor includes carbon black having a hollow structure. The negative electrode active material includes a carbon material.

### CROSS REFERENCE TO RELATED APPLICATIONS

The present application is a continuation of PCT patent application no. PCT/JP2021/003487, filed on Feb. 1, 2021, which claims priority to Japanese patent application no. JP2020-030308, filed on Feb. 26, 2020, the entire contents of which are incorporate herein by reference.

### BACKGROUND

The present application relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution. A configuration of the secondary battery has been considered in various ways.

Specifically, in order to obtain a characteristic such as a superior storage characteristic, a LiCoO₂-based compound is used as a positive electrode active material, and, for example, a fluorine atom is detected in XPS analysis of a surface of a positive electrode. In order to improve a cyclability characteristic, a portion (a first region) of a positive electrode active material includes lithium cobalt oxide, and, for example, a range of fluorine concentration as measured by X-ray photoelectron spectroscopy is defined. In order to improve adhesiveness between an electrode and a separator, an oxygen atom ratio as measured on a surface of a vinylidene fluoride copolymer particle by XPS is defined. The vinylidene fluoride copolymer particle includes vinylidene fluoride and a compound that includes a functional group including an oxygen atom.

### SUMMARY

The present application relates to a secondary battery.

Although consideration has been given in various ways to improve performance of a secondary battery, there is still room for improvement in terms of achieving both improvement of energy density and reduction of electric resistance.

The present technology has been made in view of such an issue, and is related to providing a secondary battery that is able to achieve both improvement of energy density and reduction of electric resistance according to an embodiment.

A secondary battery according to an embodiment of the present technology includes a positive electrode, a negative electrode, and an electrolytic solution. The positive electrode includes a positive electrode active material layer. The positive electrode active material layer includes a positive electrode active material, a positive electrode binder, and a positive electrode conductor. The negative electrode includes a negative electrode active material. The positive electrode active material includes a lithium-cobalt composite oxide. The positive electrode binder includes a vinylidene fluoride polymer having a melting point of higher than or equal to 160° C. and lower than or equal to 170° C. The positive electrode conductor includes carbon black having a hollow structure. The negative electrode active material includes a carbon material. A ratio of a weight of the positive electrode active material to a sum of the weight of the positive electrode active material, a weight of the positive electrode binder, and a weight of the positive electrode conductor is greater than or equal to 97.9 wt % and less than or equal to 98.5 wt %. A ratio of the weight of the positive electrode binder to the sum of the weight of the positive electrode active material, the weight of the positive electrode binder, and the weight of the positive electrode conductor is greater than or equal to 0.8 wt % and less than or equal to 1.4 wt %. A ratio of the weight of the positive electrode conductor to the sum of the weight of the positive electrode active material, the weight of the positive electrode binder, and the weight of the positive electrode conductor is greater than or equal to 0.5 wt % and less than or equal to 1.1 wt %. A volume density of the positive electrode active material layer is 4.15 g/cm³ or greater. An element concentration of a fluorine atom as measured by surface analysis of the positive electrode active material layer using X-ray photoelectron spectroscopy is greater than or equal to 1.9% and less than or equal to 3.0%.

According to the secondary battery of an embodiment of the present technology, the positive electrode active material includes the lithium-cobalt composite oxide, the positive electrode binder includes the vinylidene fluoride polymer having the melting point described above, the positive electrode conductor includes the carbon black having the hollow structure, and the negative electrode active material includes the carbon material. In addition, the ratio of the weight of each of the positive electrode active material, the positive electrode binder, and the positive electrode conductor, the volume density of the positive electrode active material layer, and the element concentration of the fluorine atom as measured by the surface analysis of the positive electrode active material layer using the X-ray photoelectron spectroscopy are within the above-described ranges. Accordingly, it is possible to achieve both improvement of the energy density and reduction of the electric resistance.

Here, the term “lithium-cobalt composite oxide” is a generic term for an oxide including lithium and cobalt as constituent elements, and the term “vinylidene fluoride polymer” is a generic term for a polymer including vinylidene fluoride as a polymerization unit. Details of each of the lithium-cobalt composite oxide and the vinylidene fluoride polymer will be described later.

Note that effects of the present technology are not necessarily limited to those described herein and may include any of a series of effects in relation to the present technology.

### BRIEF DESCRIPTION OF THE FIGURES

FIG. 1 is a perspective view of a configuration of a secondary battery according to an embodiment of the present technology.

FIG. 2 is a sectional view of a configuration of a battery device illustrated in FIG. 1.

FIG. 3 is a block diagram illustrating a configuration of an application example of the secondary battery.

### DETAILED DESCRIPTION

The present technology is described below in further detail including with reference to the drawings according to an embodiment.

A description is given first of a secondary battery according to an embodiment of the present technology.

The secondary battery to be described here is a secondary battery that obtains a battery capacity using insertion and extraction of an electrode reactant, and includes a positive electrode, a negative electrode, and an electrolytic solution which is a liquid electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

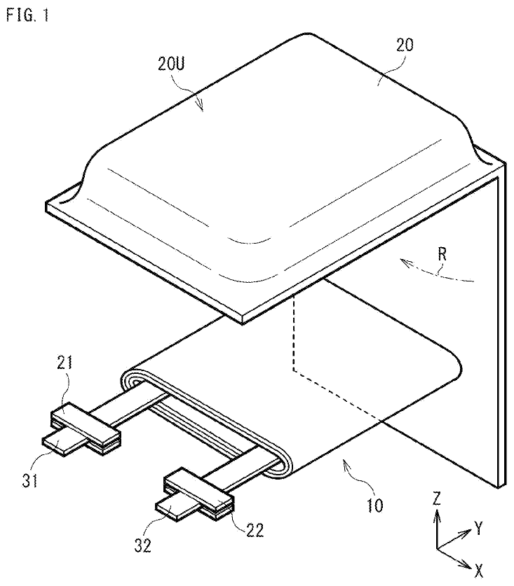

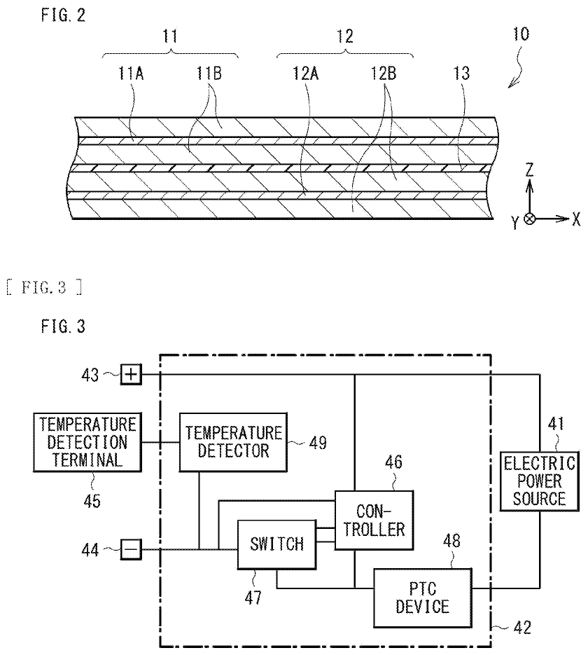

FIG. 1 illustrates a perspective configuration of the secondary battery. FIG. 2 illustrates a sectional configuration of a battery device 10 illustrated in FIG. 1. Note that FIG. 1 illustrates a state in which the battery device 10 and an outer package film 20 are separated away from each other, and FIG. 2 illustrates only a portion of the battery device 10.

As illustrated in FIG. 1, the secondary battery includes the battery device 10, the outer package film 20, a positive electrode lead 31, and a negative electrode lead 32. The secondary battery described here is a secondary battery of a laminated-film type. The secondary battery of the laminated-film type includes an outer package member having flexibility or softness, that is, the outer package film 20, to contain the battery device 10.

The outer package film 20 is a single film-shaped member and is foldable in a direction of an arrow R (a dash-dotted line), as illustrated in FIG. 1. The outer package film 20 contains the battery device 10 as described above, and thus contains the positive electrode 11, the negative electrode 12, and an electrolytic solution to be described later. The outer package film 20 has a depression part 20U to place the battery device 10 therein. The depression part 20U is a so-called deep drawn part.

Specifically, the outer package film 20 is a three-layered laminated film including a fusion-bonding layer, a metal layer, and a surface protective layer that are stacked in this order from an inner side. In a state in which the outer package film 20 is folded, outer edges of the fusion-bonding layer opposed to each other are fusion-bonded to each other. As a result, the outer package film 20 has a pouch-shaped structure that allows the battery device 10 to be sealed therein. The fusion-bonding layer includes a polymer compound such as polypropylene. The metal layer includes a metal material such as aluminum. The surface protective layer includes a polymer compound such as nylon.

Note that the outer package film 20 is not particularly limited in configuration or the number of layers, and may be single-layered or two-layered, or may include four or more layers. In other words, the outer package film 20 is not limited to a laminated film, and may be a single-layer film.

A sealing film 21 is interposed between the outer package film 20 and the positive electrode lead 31. A sealing film 22 is interposed between the outer package film 20 and the negative electrode lead 32. The sealing films 21 and 22 are members that each prevent entry of, for example, outside air into the outer package film 20, and each include one or more of polymer compounds, including polyolefin, that have adherence to both the positive electrode lead 31 and the negative electrode lead 32. Examples of the polyolefin include polyethylene, polypropylene, modified polyethylene, and modified polypropylene. Note that the sealing film 21, the sealing film 22, or both may be omitted.

As illustrated in FIGS. 1 and 2, the battery device 10 is contained inside the outer package film 20, and includes the positive electrode 11, the negative electrode 12, a separator 13, and the electrolytic solution (not illustrated). The positive electrode 11, the negative electrode 12, and the separator 13 are each impregnated with the electrolytic solution.

Here, the battery device 10 is a wound electrode body, that is, a structure in which the positive electrode 11 and the negative electrode 12 are stacked on each other with the separator 13 interposed therebetween, and the stack of the positive electrode 11, the negative electrode 12, and the separator 13 is wound about a winding axis. The winding axis is a virtual axis extending in a Y-axis direction. Accordingly, the positive electrode 11 and the negative electrode 12 are opposed to each other with the separator 13 interposed therebetween.

The battery device 10 has an elongated three-dimensional shape. In other words, a section of the battery device 10 intersecting the winding axis, that is, a section of the battery device 10 along an XZ plane, has an elongated shape defined by a major axis and a minor axis, and more specifically, has an elongated, generally elliptical shape. The major axis is a virtual axis that extends in an X-axis direction and has a relatively large length. The minor axis is a virtual axis that extends in a Z-axis direction intersecting the X-axis direction and has a relatively small length.

As illustrated in FIG. 2, the positive electrode 11 includes a positive electrode active material layer 11B. Here, the positive electrode 11 includes, together with the positive electrode active material layer 11B described above, a positive electrode current collector 11A that supports the positive electrode active material layer 11B.

Specifically, the positive electrode 11 includes the positive electrode current collector 11A having two opposed surfaces, and the positive electrode active material layer 11B disposed on each of the two opposed surfaces of the positive electrode current collector 11A. Accordingly, the positive electrode 11 includes two positive electrode active material layers 11B. Note that the positive electrode active material layer 11B may be disposed only on one of the two opposed surfaces of the positive electrode current collector 11A, and the positive electrode 11 may accordingly include only one positive electrode active material layer 11B.

The positive electrode current collector 11A includes one or more of electrically conductive materials including, without limitation, a metal material. Examples of the metal material include aluminum, nickel, and stainless steel. The positive electrode active material layer 11B includes a positive electrode active material, a positive electrode binder, and a positive electrode conductor. A method of forming the positive electrode active material layer 11B is not particularly limited, and specifically, one or more methods are selected from among a coating method and other methods.

The positive electrode active material includes a lithium-containing compound into which lithium is insertable and from which lithium is extractable, and more specifically, includes one or more of lithium-cobalt composite oxides. The term “lithium-cobalt composite oxide” is a generic term for an oxide including lithium and cobalt as constituent elements, as described above. The lithium-cobalt composite oxide has a layered rock-salt crystal structure. A reason for this is that a high energy density is obtainable.

The lithium-cobalt composite oxide is not particularly limited in kind or composition, as long as the oxide includes lithium and cobalt as constituent elements. Specifically, the lithium-cobalt composite oxide includes lithium, cobalt, and another element as constituent elements. The other element is one or more of elements belonging to groups 1 to 17 in the long period periodic table of elements (excluding lithium, cobalt, and oxygen).

More specifically, the lithium-cobalt composite oxide includes one or more of compounds represented by Formula (1) below. A reason for this is that a high energy density is stably obtainable.

LiₓCo_{1-y}MyO_{2-z}X_{z} (1)

where:
M is at least one of Ti, V, Cr, Mn, Fe, Ni, Cu, Na, Mg, Al, Si, Sn, K, Ca, Zn, Ga, Sr, Y, Zr, Nb, Mo, Ba, La, W, or B;
X is at least one of F, Cl, Br, I, or S;
x, y, and z satisfy 0.8<x<1.2, 0≤y<0.15, and 0≤z<0.05;
a composition of Li differs depending on a charge and discharge state; and
a value of x is a value in a completely discharged state.

As is apparent from Formula (1), the lithium-cobalt composite oxide is an oxide including lithium, cobalt, a first other element (M), and a second other element (X) as constituent elements. Note that, as is apparent from a value range that y can take (y≥0), the lithium-cobalt composite oxide may include the first other element (M) as a constituent element, or may not include the first other element (M) as a constituent element. In addition, as is apparent from a value range that z can take (z≥0), the lithium-cobalt composite oxide may include the second other element (X) as a constituent element, or may not include the second other element (X) as a constituent element.

Specific examples of the lithium-cobalt composite oxide include LiCoO₂, LiCo_{0.90}Al_{0.10}O₂, LiCo_{0.98}Al_{0.02}O₂, LiCo_{0.98}Al_{0.01}Mg_{0.01}O₂, LiCo_{0.98}Al_{0.01}Mg_{0.01}O_{1.98}F_{0.02}, LiCo_{0.98}Mn_{0.02}O₂, LiCo_{0.98}Zr_{0.02}O₂, and LiCo_{0.98}Ti_{0.02}O₂.

The positive electrode active material may further include one or more of other lithium-containing compounds, as long as the positive electrode active material includes the lithium-cobalt composite oxide described above.

The other lithium-containing compound is not particularly limited in kind, and specific examples thereof include a lithium-transition-metal compound. The term “lithium-transition-metal compound” is a generic term for a compound including lithium and one or more transition metal elements as constituent elements. The lithium-transition-metal compound may further include another element. Details of the other element are as described above. Note that the lithium-cobalt composite oxide described above is excluded from the lithium-transition-metal compound described here.

The lithium-transition-metal compound is not particularly limited in kind, and specific examples thereof include an oxide, a phosphoric acid compound, a silicic acid compound, and a boric acid compound. Specific examples of the oxide include LiNiO₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes a binding material, and more specifically, includes one or more of vinylidene fluoride polymers each having a low melting point. The term “vinylidene fluoride polymer” is a generic term for a polymer including vinylidene fluoride as a polymerization unit, as described above. The melting point of the polymer is within a range from 160° C. to 170° C. both inclusive.

A reason for this is that, as will be described later, a mixed film of the positive electrode binder and the positive electrode conductor covers a surface of the positive electrode active material as a result of the positive electrode 11 being compression-molded in a process of fabricating the positive electrode 11 in a process of manufacturing the secondary battery. This reduces friction between particles (i.e., inter-particle friction) of the positive electrode active material, and thus prevents the positive electrode active material from being easily damaged at the time of compression-molding the positive electrode active material layer 11B. Examples of the damage to the positive electrode active material include breakage of the positive electrode active material and occurrence of a crack in the positive electrode active material.

In the following, in order to distinguish between the above-described vinylidene fluoride polymer having the low melting point within a range from 160° C. to 170° C. both inclusive and a vinylidene fluoride polymer having a high melting point of higher than 170° C., more specifically higher than 170° C. and lower than or equal to 175° C., the former polymer is referred to as a “low-melting-point vinylidene fluoride polymer”, and the latter polymer is referred to as a “high-melting-point vinylidene fluoride polymer”. The melting point of the high-melting-point vinylidene fluoride polymer is a temperature higher than 170° C., more specifically a temperature within a range of higher than 170° C. and lower than or equal to 175° C., as described above.

The low-melting-point vinylidene fluoride polymer is not particularly limited in configuration, as long as the polymer has the low melting point and includes vinylidene fluoride as a polymerization unit. Accordingly, the low-melting-point vinylidene fluoride polymer may be a homopolymer, a copolymer, or both.

The low-melting-point vinylidene fluoride polymer that is a homopolymer is so-called polyvinylidene difluoride. Polyvinylidene difluoride serving as the low-melting-point vinylidene fluoride polymer is mainly a polymer resulting from introducing one or more functional groups into normal polyvinylidene difluoride serving as the high-melting-point vinylidene fluoride polymer. In other words, polyvinylidene difluoride serving as the low-melting-point vinylidene fluoride polymer is a polymer resulting from modifying normal polyvinylidene difluoride using one or more functional groups, thus having the low melting point.

The low-melting-point vinylidene fluoride polymer that is a copolymer includes vinylidene fluoride and one or more monomers (excluding vinylidene fluoride) as a polymerization unit, and is a polymer in which vinylidene fluoride and the one or more monomers are copolymerized. In other words, the low-melting-point vinylidene fluoride polymer that is a copolymer includes not only vinylidene fluoride but also the one or more monomers as a polymerization unit, thus having the low melting point.

The monomer is not particularly limited in kind, as long as the monomer is able to achieve the melting point of the low-melting-point vinylidene fluoride polymer, i.e., from 160° C. to 170° C. both inclusive, and specific examples thereof include hexafluoropropylene. A copolymerization amount of the monomer in the copolymer (the low-melting-point vinylidene fluoride polymer) is not particularly limited, and may be freely chosen.

The positive electrode binder may further include one or more of other binding materials, as long as the positive electrode binder includes the low-melting-point vinylidene fluoride polymer described above. Note that the low-melting-point vinylidene fluoride polymer is excluded from the other binding material described here.

Examples of the other binding material include a synthetic rubber and a polymer compound. Specific examples of the synthetic rubber include a styrene-butadiene-based rubber, a fluorine-based rubber, and ethylene propylene diene. Specific examples of the polymer compound include normal polyvinylidene difluoride serving as the high-melting-point vinylidene fluoride polymer (having the melting point of higher than 170° C. and lower than or equal to 175° C.), polyimide, and carboxymethyl cellulose.

The positive electrode conductor includes an electrically conductive material, and more specifically, includes one or more of carbon blacks each having a hollow structure. A reason for this is that, as described above, the mixed film of the positive electrode binder and the positive electrode conductor covers the surface of the positive electrode active material when the positive electrode 11 is compression-molded in the process of manufacturing the secondary battery, which reduces the friction between the particles of the positive electrode active material, and thus prevents the positive electrode active material from being easily damaged.

Specific examples of the carbon black having the hollow structure include Ketjen black. A reason for this is that this makes it easier for the mixed film of the positive electrode binder and the positive electrode conductor to cover the surface of the positive electrode active material, thus further reducing the friction between the particles of the positive electrode active material.

The positive electrode conductor may further include one or more of other electrically conductive materials, as long as the positive electrode conductor includes the carbon black having the hollow structure described above. Note that the carbon black having the hollow structure is excluded from the other electrically conductive material described here.

The other electrically conductive material is a carbon material. Specific examples of the carbon material include graphite and acetylene black. Examples of the other electrically conductive material may include a metal material and a polymer compound.

The positive electrode active material layer 11B may further include one or more of additives. A kind of the additive may be freely chosen depending on, for example, a function of the additive. Specific examples of the additive include polyvinylpyrrolidone. A reason for this is that dispersibility of a material such as the positive electrode active material is promoted in a process of preparing a positive electrode mixture slurry to be described later. In other words, even if an aggregate of the material such as the positive electrode active material is present, it becomes easier for the aggregate to be dispersed, thus improving the dispersibility of the material such as the positive electrode active material. This improves a coating property of the positive electrode mixture slurry, and improves adherence of the positive electrode active material layer 11B to the positive electrode current collector 11A. Although not particularly limited, a content of polyvinylpyrrolidone in the positive electrode active material layer 11B is specifically within a range from 0.01 wt % to 0.05 wt % both inclusive.

A mixture ratio between the positive electrode active material, the positive electrode binder, and the positive electrode conductor is set to fall within a predetermined range. In particular, the mixture ratio of each of the positive electrode binder and the positive electrode conductor is set to be sufficiently small with respect to the mixture ratio of the positive electrode active material. To put it the other way around, the mixture ratio of the positive electrode active material is set to be sufficiently large with respect to the mixture ratio of each of the positive electrode binder and the positive electrode conductor.

Specifically, a ratio R1 of a weight M1 of the positive electrode active material to the sum of the weight M1 of the positive electrode active material, a weight M2 of the positive electrode binder, and a weight M3 of the positive electrode conductor is within a range from 97.9 wt % to 98.5 wt % both inclusive. The ratio R1 is calculated by R1=[M1/(M1+M2+M3)]×100.

A ratio R2 of the weight M2 of the positive electrode binder to the sum of the weight M1 of the positive electrode active material, the weight M2 of the positive electrode binder, and the weight M3 of the positive electrode conductor is within a range from 0.8 wt % to 1.4 wt % both inclusive. The ratio R2 is calculated by R2=[M2/(M1+M2+M3)]×100.

A ratio R3 of the weight M3 of the positive electrode conductor to the sum of the weight M1 of the positive electrode active material, the weight M2 of the positive electrode binder, and the weight M3 of the positive electrode conductor is within a range from 0.5 wt % to 1.1 wt % both inclusive. The ratio R3 is calculated by R3=[M3/(M1+M2+M3)]×100.

The ratios R1, R2, and R3 are within the above-described respective ranges for the following reason. In a case of making the weight M1 of the positive electrode active material relatively large and making each of the weight M2 of the positive electrode binder and the weight M3 of the positive electrode conductor small, a relationship between the ratios R1, R2, and R3 is mutually optimized. As a result, firstly, a proportion of the positive electrode active material in the positive electrode active material layer 11B increases with an increase in the ratio R1, thus allowing for a high energy density. Secondly, it becomes easier for the mixed film of the positive electrode binder and the positive electrode conductor to uniformly cover the surface of the positive electrode active material, which stably reduces the friction between the particles of the positive electrode active material, and thus stably prevents the positive electrode active material from being easily damaged at the time of compression-molding the positive electrode active material layer 11B. Thirdly, even if each of the ratios R2 and R3 is small, it becomes easier for the particles of the positive electrode active material to be bound to each other via the mixed film, and it becomes easier for the particles of the positive electrode active material to be electrically coupled to each other via the mixed film.

A procedure of identifying each of the ratios R1, R2, and R3 is as described below. First, the secondary battery is disassembled to thereby collect the positive electrode 11. Thereafter, the positive electrode 11 (the positive electrode active material layer 11B) is analyzed by thermogravimetric analysis to thereby measure each of the weight M1 of the positive electrode active material, the weight M2 of the positive electrode binder, and the weight M3 of the positive electrode conductor. Lastly, the ratios R1, R2, and R3 are each calculated on the basis of the weights M1, M2, and M3.

As described above, the ratios R1, R2, and R3 being within the respective predetermined ranges reduces the friction between the particles of the positive electrode active material, and thus prevents the positive electrode active material from being easily damaged at the time of compression-molding the positive electrode active material layer 11B. This makes it possible to sufficiently compression-mold the positive electrode active material layer 11B, while suppressing the damage to the positive electrode active material, in the process of fabricating the positive electrode 11.

Specifically, a volume density of the positive electrode active material layer 11B in which the friction between the particles of the positive electrode active material is reduced because of the ratios R1, R2, and R3 being within the respective predetermined ranges sufficiently increases, as compared with a volume density of the positive electrode active material layer 11B in which the friction between the particles of the positive electrode active material is not reduced because of the ratios R1, R2, and R3 being outside the respective predetermined ranges. Specifically, the volume density of the positive electrode active material layer 11B is 4.15 g/cm³ or greater, preferably within a range from 4.15 g/cm³ to 4.20 g/cm³ both inclusive.

In a case where a surface of the positive electrode active material layer 11B is analyzed by elemental analysis using X-ray photoelectron spectroscopy (XPS), an element concentration of a fluorine atom as measured on the surface of the positive electrode active material layer 11B is sufficiently small. Specifically, the element concentration of the fluorine atom as measured by the surface analysis of the positive electrode active material layer 11B using the XPS is within a range from 1.9% to 3.0% both inclusive. A reason for this is that an amount of a reaction product of fluorine (LiF) formed decreases in the positive electrode active material layer 11B.

In detail, the positive electrode binder includes the low-melting-point vinylidene fluoride polymer, and the ratio R2 of the positive electrode binder is sufficiently small with respect to the ratio R1 of the positive electrode active material, as described above. Accordingly, the reaction product of fluorine is not easily formed by the fluorine atom in the positive electrode binder when the positive electrode active material layer 11B is heated in the process of manufacturing the secondary battery. This prevents the reaction product of fluorine from being easily formed at the time of heating the positive electrode active material layer 11B even if the positive electrode binder includes fluorine as a constituent element. As a result, the element concentration of the fluorine atom as measured by the surface analysis of the positive electrode active material layer 11B using the XPS becomes sufficiently small.

The negative electrode 12 is opposed to the positive electrode 11 with the separator 13 interposed therebetween, as illustrated in FIG. 2. The negative electrode 12 includes a negative electrode current collector 12A having two opposed surfaces, and two negative electrode active material layers 12B disposed on the respective two opposed surfaces of the negative electrode current collector 12A. Note that the negative electrode active material layer 12B may be disposed only on one of the two opposed surfaces of the negative electrode current collector 12A.

The negative electrode current collector 12A includes one or more of electrically conductive materials including, without limitation, a metal material. Examples of the metal material include copper, aluminum, nickel, and stainless steel. The negative electrode active material layer 12B includes one or more of negative electrode active materials into which lithium is insertable and from which lithium is extractable, and may further include, for example, a negative electrode binder and a negative electrode conductor. A method of forming the negative electrode active material layer 12B is not particularly limited, and specifically, one or more methods are selected from among a coating method and other methods.

The negative electrode active material includes an active-material constituent, and more specifically, includes one or more of carbon materials. A reason for this is that a high energy density is obtainable. Examples of the carbon material include graphite, graphitizable carbon, and non-graphitizable carbon. Examples of the graphite include natural graphite and artificial graphite. In particular, the carbon material preferably includes artificial graphite, natural graphite, or both. A reason for this is that this makes it easier for charging and discharging reactions to proceed smoothly and stably in the negative electrode 12.

The negative electrode active material may further include one or more of silicon-containing materials, together with the carbon material described above. A reason for this is that this further increases the energy density. The term “silicon-containing material” is a generic term for a material including silicon as a constituent element. The silicon-containing material may be a simple substance of silicon, a silicon alloy, a silicon compound, a mixture of two or more thereof, or a material including two or more phases thereof. A mixture ratio between the carbon material and the silicon-containing material is not particularly limited, and may be freely chosen.

Specific examples of the silicon-containing material include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VS₁₂, WS₁₂, ZnS₁₂, SiOₓ (0<x≤2), and LiSiO. Note that x of SiOₓ may satisfy 0.2<x<1.4.

The negative electrode active material may further include one or more of other active-material constituents, as long as the negative electrode active material includes the carbon material described above and includes the silicon-containing material together with the carbon material on an as-needed basis. Note that each of the carbon material and the silicon-containing material is excluded from the other active-material constituent described here.

The other active-material constituent is one or more of metal-based materials. The metal-based material is a material that includes one or more elements among metal elements and metalloid elements that are each able to form an alloy with lithium. Examples of such metal elements and metalloid elements include tin. The metal-based material may be a simple substance, an alloy, a compound, a mixture of two or more thereof, or a material including two or more phases thereof.

Specific examples of the metal-based material include SnO_{w} (0<w≤2), SnSiO₃, LiSnO, and Mg₂Sn. Note that a material including silicon and tin as constituent elements shall be classified as the metal-based material, not as the silicon-containing material.

The negative electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride serving as the low-melting-point vinylidene fluoride polymer, polyvinylidene difluoride serving as the high-melting-point vinylidene fluoride polymer, polyimide, and carboxymethyl cellulose.

The negative electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

The separator 13 is an insulating porous film interposed between the positive electrode 11 and the negative electrode 12 as illustrated in FIG. 2, and allows lithium ions to pass therethrough while preventing a contact between the positive electrode 11 and the negative electrode 12. The separator 13 includes one or more of polymer compounds including, without limitation, polytetrafluoroethylene, polypropylene, and polyethylene.

At the positive electrode 11 and the separator 13, the positive electrode active material layer 11B is interposed between the positive electrode current collector 11A and the separator 13. Accordingly, the positive electrode active material layer 11B adheres to each of the positive electrode current collector 11A and the separator 13.

Here, in the process of fabricating the positive electrode 11, the positive electrode active material layer 11B is formed by applying the positive electrode mixture slurry on the surface of the positive electrode current collector 11A, as will be described later. An adhesion strength Si of the positive electrode active material layer 11B to the positive electrode current collector 11A is thus made larger than an adhesion strength S2 of the positive electrode active material layer 11B to the separator 13 in the completed secondary battery. A reason for this is that this makes the positive electrode active material layer 11B sufficiently adhere to the positive electrode current collector 11A, and thereby improves an electric coupling characteristic of the positive electrode 11.

In examining a magnitude relationship between the adhesion strengths Si and S2, the secondary battery is disassembled to thereby collect the positive electrode 11 and the separator 13 adhering to each other, following which the separator 13 is peeled from the positive electrode 11. Thus, a case where the positive electrode active material layer 11B remains on the positive electrode current collector 11A without being peeled together with the separator 13 indicates that the adhesion strength Si is larger than the adhesion strength S2. In contrast, a case where the positive electrode active material layer 11B is peeled from the positive electrode current collector 11A together with the separator 13 indicates that the adhesion strength S1 is smaller than the adhesion strength S2.

Needless to say, each of the adhesion strengths Si and S2 may be actually measured by means of, for example, a peel tester for 180-degree peeling to thereby examine the magnitude relationship between the adhesion strengths Si and S2.

The electrolytic solution includes a solvent and an electrolyte salt.

The solvent includes one or more of non-aqueous solvents (organic solvents). An electrolytic solution including a non-aqueous solvent is a so-called non-aqueous electrolytic solution. Examples of the non-aqueous solvent include esters and ethers. More specific examples of the non-aqueous solvent include a carbonic-acid-ester-based compound, a carboxylic-acid-ester-based compound, and a lactone-based compound. A reason for this is that a dissociation property of the electrolyte salt improves and a high mobility of ions is obtainable.

Specifically, examples of the carbonic-acid-ester-based compound include a cyclic carbonic acid ester and a chain carbonic acid ester. Specific examples of the cyclic carbonic acid ester include ethylene carbonate and propylene carbonate. Specific examples of the chain carbonic acid ester include dimethyl carbonate, diethyl carbonate, and methyl ethyl carbonate.

Examples of the carboxylic-acid-ester-based compound include a carboxylic acid ester. Specific examples of the carboxylic acid ester include ethyl acetate, ethyl propionate, propyl propionate, and ethyl trimethyl acetate.

Examples of the lactone-based compound include a lactone. Specific examples of the lactone include γ-butyrolactone and γ-valerolactone. Note that examples of the ethers other than the lactone-based compounds described above may include 1,2-dimethoxyethane, tetrahydrofuran, 1,3-dioxolane, and 1,4-dioxane.

Further, examples of the non-aqueous solvent may include an unsaturated cyclic carbonic acid ester, a halogenated carbonic acid ester, a sulfonic acid ester, a phosphoric acid ester, an acid anhydride, a nitrile compound, and an isocyanate compound. A reason for this is that chemical stability of the electrolytic solution improves.

Specific examples of the unsaturated cyclic carbonic acid ester include vinylene carbonate (1,3-dioxol-2-one), vinylethylene carbonate (4-vinyl-1,3-dioxolane-2-one), and methylene ethylene carbonate (4-methylene-1,3-dioxolane-2-one). Specific examples of the halogenated carbonic acid ester include fluoroethylene carbonate (4-fluoro-1,3-dioxolane-2-one) and difluoroethylene carbonate (4,5-difluoro-1,3-dioxolane-2-one). Specific examples of the sulfonic acid ester include 1,3-propane sultone and 1,3-propene sultone. Examples of the phosphoric acid ester include trimethyl phosphate and triethyl phosphate.

Examples of the acid anhydride include a cyclic dicarboxylic acid anhydride, a cyclic disulfonic acid anhydride, and a cyclic carboxylic acid sulfonic acid anhydride. Specific examples of the cyclic dicarboxylic acid anhydride include succinic anhydride, glutaric anhydride, and maleic anhydride. Specific examples of the cyclic disulfonic acid anhydride include 1,2-ethanedisulfonic anhydride and 1,3-propanedisulfonic anhydride. Specific examples of the cyclic carboxylic acid sulfonic acid anhydride include sulfobenzoic anhydride, sulfopropionic anhydride, and sulfobutyric anhydride.

Examples of the nitrile compound include a mononitrile compound and a dinitrile compound. Specific examples of the mononitrile compound include acetonitrile. Specific examples of the dinitrile compound include succinonitrile, glutaronitrile, and adiponitrile. Specific examples of the isocyanate compound include hexamethylene diisocyanate.

The electrolyte salt includes one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium difluoro(oxalato)borate (LiBF₂(C₂O₄)), and lithium bis(oxalato)borate (LiB(C₂O₄)₂).

Although not particularly limited, a content of the electrolyte salt is specifically within a range from 0.3 mol/kg to 3.0 mol/kg both inclusive with respect to the solvent. A reason for this is that a high ionic conductivity is obtainable.

The positive electrode lead 31 is a positive electrode terminal coupled to the positive electrode 11 (the positive electrode current collector 11A), and includes one or more of electrically conductive materials including, without limitation, aluminum. A shape of the positive electrode lead 31 is not particularly limited, and specifically, one or more shapes are selected from among a thin plate shape, a meshed shape, and other shapes.

The negative electrode lead 32 is a negative electrode terminal coupled to the negative electrode 12 (the negative electrode current collector 12A), and includes one or more of electrically conductive materials including, without limitation, copper, nickel, and stainless steel. Details of a shape of the negative electrode lead 32 are similar to those of the shape of the positive electrode lead 31 described above.

Here, as illustrated in FIG. 1, the positive electrode lead 31 and the negative electrode lead 32 are led out in respective directions that are common to each other, from inside to outside the outer package film 20. Note that the positive electrode lead 31 and the negative electrode lead 32 may be led out in respective directions that are different from each other.

The number of the positive electrode leads 31 is one. Note that the number of the positive electrode leads 31 is not particularly limited, and may be two or more. In particular, if the number of the positive electrode leads 31 is two or more, the secondary battery decreases in electrical resistance. The description given here in relation to the number of the positive electrode leads 31 also applies to the number of the negative electrode leads 32. Accordingly, the number of the negative electrode leads 32 may be two or more, without being limited to one.

Upon charging the secondary battery, lithium is extracted from the positive electrode 11, and the extracted lithium is inserted into the negative electrode 12 via the electrolytic solution. Upon discharging the secondary battery, lithium is extracted from the negative electrode 12, and the extracted lithium is inserted into the positive electrode 11 via the electrolytic solution. Upon charging and discharging, lithium is inserted and extracted in an ionic state.

In a case of manufacturing the secondary battery, by a procedure described below, the positive electrode 11 and the negative electrode 12 are fabricated and the electrolytic solution is prepared, following which the secondary battery is fabricated using the positive electrode 11, the negative electrode 12, and the electrolytic solution. In the following, reference will be made where appropriate to FIGS. 1 and 2 which have been already described.

First, the positive electrode active material including the lithium-cobalt composite oxide is mixed with the positive electrode binder including the low-melting-point vinylidene fluoride polymer and the positive electrode conductor including the carbon black having the hollow structure to thereby obtain a positive electrode mixture. In this case, the mixture ratio between the positive electrode active material, the positive electrode binder, and the positive electrode conductor is adjusted to make the ratio R1 of the positive electrode active material fall within a range from 97.9 wt % to 98.5 wt % both inclusive, the ratio R2 of the positive electrode binder fall within a range from 0.8 wt % to 1.4 wt % both inclusive, and the ratio R3 of the positive electrode conductor fall within a range from 0.5 wt % to 1.1 wt % both inclusive. Note that the additive such as polyvinylpyrrolidone may be added to the positive electrode mixture on an as-needed basis.

Thereafter, the positive electrode mixture is put into a solvent such as an organic solvent to thereby prepare a paste positive electrode mixture slurry. Thereafter, the positive electrode mixture slurry is applied on each of the two opposed surfaces of the positive electrode current collector 11A to thereby form the positive electrode active material layer 11B.

Thereafter, the positive electrode active material layer 11B is compression-molded by means of, for example, a roll pressing machine. In this case, the positive electrode active material layer 11B is compression-molded until the volume density becomes 4.15 g/cm³ or greater. The positive electrode active material layer 11B may be compression-molded while being heated. The compression-molding process may be repeated multiple times.

Lastly, the positive electrode active material layer 11B is heated in a vacuum environment. In this case, a heating temperature is set to make the element concentration of the fluorine atom as measured by the surface analysis of the positive electrode active material layer 11B using the XPS fall within a range from 1.9% to 3.0% both inclusive. The heating temperature at the time of the heating may be freely chosen, and is specifically 100° C. or higher.

The positive electrode active material layer 11B is thus disposed on each of the two opposed surfaces of the positive electrode current collector 11A. In this manner, the positive electrode 11 is fabricated. In this case, the positive electrode active material layer 11B sufficiently adheres to the positive electrode current collector 11A. This makes the adhesion strength Si of the positive electrode active material layer 11B to the positive electrode current collector 11A larger than the adhesion strength S2 of the positive electrode active material layer 11B to the separator 13 in the completed secondary battery.

The negative electrode 12 is fabricated by a procedure substantially similar to the fabrication procedure of the positive electrode 11 described above.

Specifically, the negative electrode active material including the carbon material is mixed with materials including, without limitation, the negative electrode binder and the negative electrode conductor to thereby obtain a negative electrode mixture. Thereafter, the negative electrode mixture is put into a solvent such as an organic solvent to thereby prepare a paste negative electrode mixture slurry. Note that the silicon-containing material may be added as the negative electrode active material to the negative electrode mixture on an as-needed basis. Thereafter, the negative electrode mixture slurry is applied on each of the two opposed surfaces of the negative electrode current collector 12A to thereby form the negative electrode active material layer 12B. Thereafter, the negative electrode active material layer 12B may be compression-molded.

The negative electrode active material layer 12B is thus disposed on each of the two opposed surfaces of the negative electrode current collector 12A. In this manner, the negative electrode 12 is fabricated.

The electrolyte salt is put into a solvent. The electrolyte salt is thereby dispersed or dissolved in the solvent. As a result, the electrolytic solution is prepared.

First, the positive electrode lead 31 is coupled to the positive electrode 11 (the positive electrode current collector 11A) by a method such as a welding method, and the negative electrode lead 32 is coupled to the negative electrode 12 (the negative electrode current collector 12A) by a method such as a welding method.

Thereafter, the positive electrode 11 and the negative electrode 12 are stacked on each other with the separator 13 interposed therebetween, following which the stack of the positive electrode 11, the negative electrode 12, and the separator 13 is wound to thereby fabricate a wound body. The wound body has a configuration similar to that of the battery device 10 except that the positive electrode 11, the negative electrode 12, and the separator 13 are each not impregnated with the electrolytic solution. Thereafter, the wound body is pressed by means of, for example, a pressing machine to thereby shape the wound body into an elongated shape.

Thereafter, the wound body is placed inside the depression part 20U, following which the outer package film 20 (fusion-bonding layer/metal layer/surface protective layer) is folded to thereby cause portions of the outer package film 20 to be opposed to each other. Thereafter, outer edges of two sides of the outer package film 20 (the fusion-bonding layer) opposed to each other are bonded to each other by a method such as a thermal-fusion-bonding method to thereby contain the wound body in the pouch-shaped outer package film 20.

Lastly, the electrolytic solution is injected into the pouch-shaped outer package film 20, following which the outer edges of the remaining one side of the outer package film 20 (the fusion-bonding layer) are bonded to each other by a method such as a thermal-fusion-bonding method. In this case, the sealing film 21 is interposed between the outer package film 20 and the positive electrode lead 31, and the sealing film 22 is interposed between the outer package film 20 and the negative electrode lead 32. The wound body is thereby impregnated with the electrolytic solution. Thus, the battery device 10 which is the wound electrode body is fabricated. In this manner, the battery device 10 is sealed in the pouch-shaped outer package film 20. As a result, the secondary battery is assembled.

The assembled secondary battery is charged and discharged. Various conditions including, without limitation, an environment temperature, the number of times of charging and discharging (i.e., the number of cycles), and charging and discharging conditions may be freely set. A film is thereby formed on a surface of, for example, the negative electrode 12. This allows the secondary battery to be in an electrochemically stable state. As a result, the secondary battery using the outer package film 20, i.e., the secondary battery of the laminated-film type is completed.

According to the secondary battery, the positive electrode active material includes the lithium-cobalt composite oxide, the positive electrode binder includes the low-melting-point vinylidene fluoride polymer, the positive electrode conductor includes the carbon black having the hollow structure, and the negative electrode active material includes the carbon material. In addition, the ratio R1 of the positive electrode active material is within a range from 97.9 wt % to 98.5 wt % both inclusive, the ratio R2 of the positive electrode binder is within a range from 0.8 wt % to 1.4 wt % both inclusive, the ratio R3 of the positive electrode conductor is within a range from 0.5 wt % to 1.1 wt % both inclusive, the volume density of the positive electrode active material layer 11B is 4.15 g/cm³ or greater, and the element concentration of the fluorine atom as measured by the surface analysis of the positive electrode active material layer 11B using the XPS is within a range from 1.9% to 3.0% both inclusive.

In this case, owing to the positive electrode 11 (the positive electrode active material) including the lithium-cobalt composite oxide and the negative electrode 12 (the negative electrode active material) including the carbon material, it becomes easier for lithium to be inserted into and extracted from the positive electrode 11 and the negative electrode 12 smoothly and stably upon charging and discharging.

In addition, the ratio R1 is sufficiently large with respect to each of the ratios R2 and R3, which sufficiently increases a content of the positive electrode active material in the positive electrode active material layer 11B. Thus, an energy density per unit volume increases as compared with a case where the ratio R1 is not sufficiently large with respect to each of the ratios R2 and R3, that is, a case where the ratio R1 is less than 97.9 wt %.

Here, making the ratio R2 sufficiently small with respect to the ratio R1 causes a content of the positive electrode binder in the positive electrode active material layer 11B to decrease excessively. This results in insufficiency of the positive electrode binder, thus making it difficult for the particles of the positive electrode active material to be bound to each other via the positive electrode binder.

In addition, making the ratio R3 sufficiently small with respect to the ratio R1 causes a content of the positive electrode conductor in the positive electrode active material layer 11B to decrease excessively. This results in insufficiency of the positive electrode conductor, and thus tends to increase an internal resistance of the positive electrode 11 (an electric resistance of the positive electrode active material layer 11B).

Further, making the ratio R1 sufficiently large with respect to each of the ratios R2 and R3 causes the content of the positive electrode active material in the positive electrode active material layer 11B to increase excessively. This tends to increase the friction between the particles (i.e., the inter-particle friction) of the positive electrode active material. Thus, for example, collision between the particles of the positive electrode active material causes the positive electrode active material to be easily damaged at the time of compression-molding the positive electrode active material layer 11B, and thus tends to further increase the internal resistance of the positive electrode 11.

However, in a case where the positive electrode binder includes the low-melting-point vinylidene fluoride polymer and the positive electrode conductor includes the carbon black having the hollow structure, if the ratios R1, R2, and R3 are within the above-described respective ranges, the mixed film of the positive electrode binder and the positive electrode conductor covers the surface of the positive electrode active material, as described above.

In this case, the particles of the positive electrode active material are bound to each other via the mixed film. As a result, it becomes easier for the particles of the positive electrode active material to be bound to each other via the mixed film even if the ratio R2 is sufficiently small with respect to the ratio R1. This prevents the reaction product of fluorine (LiF) from being easily formed by the fluorine atom in the low-melting-point vinylidene fluoride polymer at the time of heating the positive electrode active material layer 11B. Specifically, the element concentration of the fluorine atom as measured by the surface analysis of the positive electrode active material layer 11B using the XPS decreases to fall within a range from 1.9% to 3.0% both inclusive, as described above.

In addition, the presence of the mixed film results in a decrease in the friction between the particles of the positive electrode active material, thus preventing the positive electrode active material from being easily damaged even if the particles of the positive electrode active material collide with each other at the time of compression-molding the positive electrode active material layer 11B. This helps to prevent the internal resistance of the positive electrode 11 from increasing even if the ratio R3 is sufficiently small with respect to the ratio R1.

Further, the positive electrode active material being prevented from being easily damaged makes it easier for the positive electrode active material layer 11B to be sufficiently compression-molded. This sufficiently increases the volume density of the positive electrode active material layer 11B, while suppressing the damage to the positive electrode active material. Specifically, the volume density of the positive electrode active material layer 11B increases to 4.15 g/cm³ or greater, as described above. This further increases the energy density per unit volume.

Based upon the above, in a case where the positive electrode active material includes the lithium-cobalt composite oxide and the negative electrode active material includes the carbon material, the energy density per unit volume increases, while an increase in the internal resistance of the positive electrode 11 is suppressed. This makes it possible to achieve both improvement of the energy density and reduction of the electric resistance.

In particular, the lithium-cobalt composite oxide may include the compound represented by Formula (1). This makes it possible to obtain a high energy density stably. Accordingly, it is possible to achieve higher effects.

The carbon black having the hollow structure may include Ketjen black. This makes it easier for the mixed film of the positive electrode binder and the positive electrode conductor to cover the surface of the positive electrode active material, which further reduces the friction between the particles of the positive electrode active material. Accordingly, it is possible to achieve higher effects.

The carbon material may include, without limitation, artificial graphite. This makes it easier for the charging and discharging reactions to proceed smoothly and stably in the negative electrode 12. Accordingly, it is possible to achieve higher effects.

The negative electrode active material may further include the silicon-containing material. This further increases the energy density per unit volume. Accordingly, it is possible to achieve higher effects.

The positive electrode active material layer 11B may further include polyvinylpyrrolidone as the additive. This promotes the dispersibility of a material such as the positive electrode active material in the positive electrode mixture slurry. This improves the coating property of the positive electrode mixture slurry, and improves the adherence of the positive electrode active material layer 11B to the positive electrode current collector 11A. Accordingly, it is possible to achieve higher effects.

The separator 13 may be interposed between the positive electrode 11 (the positive electrode current collector 11A and the positive electrode active material layer 11B) and the negative electrode 12, and the adhesion strength Si of the positive electrode active material layer 11B to the positive electrode current collector 11A may be larger than the adhesion strength S2 of the positive electrode active material layer 11B to the separator 13. This improves the electric coupling characteristic of the positive electrode 11 as compared with a case where the adhesion strength S1 is smaller than the adhesion strength S2. Accordingly, it is possible to achieve higher effects.

The secondary battery may include a lithium-ion secondary battery. This makes it possible to obtain a sufficient battery capacity stably through the use of insertion and extraction of lithium. Accordingly, it is possible to achieve higher effects.

Next, a description is given of modifications of the above-described secondary battery. The configuration of the secondary battery is appropriately modifiable as described below. Note that any two or more of the following series of modifications may be combined.

The separator 13 which is a porous film is used. However, although not specifically illustrated here, a separator of a stacked type including a polymer compound layer may be used instead of the separator 13 which is the porous film.

Specifically, the separator of the stacked type includes the porous film having two opposed surfaces, and a polymer compound layer disposed on one of or each of the two opposed surfaces of the porous film. A reason for this is that adherence of the separator to each of the positive electrode 11 and the negative electrode 12 improves to suppress the occurrence of misalignment of the battery device 10. This helps to prevent the secondary battery from easily swelling even if, for example, a decomposition reaction of the electrolytic solution occurs. The polymer compound layer includes a polymer compound such as polyvinylidene difluoride which has superior physical strength and is electrochemically stable.

Note that the porous film, the polymer compound layer, or both may each include one or more kinds of insulating particles. A reason for this is that such insulating particles dissipate heat upon heat generation by the secondary battery, thus improving safety or heat resistance of the secondary battery. Examples of the insulating particles include inorganic particles and resin particles. Specific examples of the inorganic particles include particles of aluminum oxide, aluminum nitride, boehmite, silicon oxide, titanium oxide, magnesium oxide, and zirconium oxide. Specific examples of the resin particles include particles of acrylic resin and styrene resin.

In a case of fabricating the separator of the stacked type, a precursor solution including, without limitation, the polymer compound and an organic solvent is prepared and thereafter the precursor solution is applied on one of or each of the two opposed surfaces of the porous film. In another example, the porous film may be immersed in the precursor solution. In this case, insulating particles may be added to the precursor solution on an as-needed basis.

Similar effects are obtainable also in the case where the separator of the stacked type is used, as lithium ions are movable between the positive electrode 11 and the negative electrode 12.

The electrolytic solution which is a liquid electrolyte is used. However, although not specifically illustrated here, an electrolyte layer which is a gel electrolyte may be used instead of the electrolytic solution.

In the battery device 10 including the electrolyte layer, the positive electrode 11 and the negative electrode 12 are wound with the separator 13 and the electrolyte layer interposed therebetween. The electrolyte layer is interposed between the positive electrode 11 and the separator 13, and between the negative electrode 12 and the separator 13.

Specifically, the electrolyte layer includes a polymer compound together with the electrolytic solution. The electrolytic solution is held by the polymer compound in the electrolyte layer. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, without limitation, the electrolytic solution, the polymer compound, and an organic solvent is prepared and thereafter the precursor solution is applied on one or both sides of the positive electrode 11 and one or both sides of the negative electrode 12.

Similar effects are obtainable also in the case where the electrolyte layer is used, as lithium ions are movable between the positive electrode 11 and the negative electrode 12 via the electrolyte layer.

Next, a description is given of applications (application examples) of the above-described secondary battery.

The applications of the secondary battery are not particularly limited as long as they are, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. In these applications, one secondary battery or a plurality of secondary batteries may be used.

In particular, the battery pack is effectively applied to relatively large-sized equipment, etc., including an electric vehicle, an electric power storage system, and an electric power tool. The battery pack may include a single battery, or may include an assembled battery. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

One of application examples of the secondary battery will now be described in detail. The configuration of the application example described below is merely an example, and is appropriately modifiable.

FIG. 3 illustrates a block configuration of a battery pack. The battery pack described here is a simple battery pack (a so-called soft pack) including one secondary battery, and is to be mounted on, for example, electronic equipment typified by a smartphone.

As illustrated in FIG. 3, the battery pack includes an electric power source 41 and a circuit board 42. The circuit board 42 is coupled to the electric power source 41, and includes a positive electrode terminal 43, a negative electrode terminal 44, and a temperature detection terminal 45 (a so-called T terminal).

The electric power source 41 includes one secondary battery. The secondary battery has a positive electrode lead coupled to the positive electrode terminal 43 and a negative electrode lead coupled to the negative electrode terminal 44. The electric power source 41 is couplable to outside via the positive electrode terminal 43 and the negative electrode terminal 44, and is thus chargeable and dischargeable via the positive electrode terminal 43 and the negative electrode terminal 44. The circuit board 42 includes a controller 46, a switch 47, a thermosensitive resistive device (a positive temperature coefficient (PTC) device) 48, and a temperature detector 49. However, the PTC device 48 may be omitted.

The controller 46 includes, for example, a central processing unit (CPU) and a memory, and controls an overall operation of the battery pack. The controller 46 detects and controls a use state of the electric power source 41 on an as-needed basis.

If a voltage of the electric power source 41 (the secondary battery) reaches an overcharge detection voltage or an overdischarge detection voltage, the controller 46 turns off the switch 47. This prevents a charging current from flowing into a current path of the electric power source 41. In addition, if a large current flows upon charging or discharging, the controller 46 turns off the switch 47 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 47 includes, for example, a charge control switch, a discharge control switch, a charging diode, and a discharging diode. The switch 47 performs switching between coupling and decoupling between the electric power source 41 and external equipment in accordance with an instruction from the controller 46. The switch 47 includes, for example, a metal-oxide-semiconductor field-effect transistor (MOSFET) including a metal-oxide semiconductor. The charging and discharging currents are detected on the basis of an ON-resistance of the switch 47.

The temperature detector 49 includes a temperature detection device such as a thermistor. The temperature detector 49 measures a temperature of the electric power source 41 using the temperature detection terminal 45, and outputs a result of the temperature measurement to the controller 46. The result of the temperature measurement to be obtained by the temperature detector 49 is used, for example, in a case where the controller 46 performs charge/discharge control upon abnormal heat generation or in a case where the controller 46 performs a correction process upon calculating a remaining capacity.

### EXAMPLES

A description is given of Examples of the present technology below.

### Experiment Examples 1 to 25

Secondary batteries were fabricated, following which the secondary batteries were evaluated for performance.

### [Fabrication of Secondary Battery]

Secondary batteries (lithium-ion secondary batteries) of the laminated-film type illustrated in FIGS. 1 and 2 were fabricated by a procedure described below.

### (Fabrication of Positive Electrode)

First, the positive electrode active material (the lithium-cobalt composite oxide) was mixed with the positive electrode binder (the low-melting-point vinylidene fluoride polymer) and the positive electrode conductor (the carbon black having the hollow structure) to thereby obtain a positive electrode mixture.

As the lithium-cobalt composite oxide, LiCoO₂ (LOC) and LiCo_{0.98}Al_{0.02}O₂ (LCOA) were used. As the low-melting-point vinylidene fluoride polymer, polyvinylidene difluoride having a low melting point (LMPVDF; an electrode binder, Kynar HSV1800 (registered trademark) available from Arkema Inc. and having a melting point within a range from 160° C. to 170° C. both inclusive) was used. As the carbon black having the hollow structure, Ketjen black (KB) was used. In a case of obtaining the positive electrode mixture, the mixture ratio between the positive electrode active material, the positive electrode binder, and the positive electrode conductor was adjusted to make the ratios R1, R2, and R3 take respective values indicated in each of Table 1 and Table 2.

Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on each of the two opposed surfaces of the positive electrode current collector 11A (an aluminum foil having a thickness of 12 μm) by means of a coating apparatus, following which the applied positive electrode mixture slurry was dried to thereby form the positive electrode active material layer 11B.

Thereafter, the positive electrode active material layer 11B was compression-molded by means of a roll pressing machine. The volume density (g/cm³) of the positive electrode active material layer 11B after the compression molding was as listed in Table 1 and Table 2. The volume density was a maximum value of the volume density of the positive electrode active material layer 11B after the compression molding.

Lastly, the positive electrode active material layer 11B was heated (at a heating temperature of 100° C.) in a vacuum environment. The positive electrode active material layer 11B was thus disposed on each of the two opposed surfaces of the positive electrode current collector 11A. In this manner, the positive electrode 11 was fabricated.

After the positive electrode 11 was completed, the surface of the positive electrode active material layer 11B was analyzed by XPS to thereby measure the element concentration (%) of the fluorine atom. This revealed the results presented in Table 1 and Table 2.

For comparison, the positive electrode 11 was fabricated by a similar procedure except that, as the negative electrode binder, the high-melting-point vinylidene fluoride polymer was used in place of the low-melting-point vinylidene fluoride polymer. As the high-melting-point vinylidene fluoride, polyvinylidene difluoride having a high melting point (HMPVDF; a high performance binder for electrode, Kureha KF polymer #7300 (registered trademark) available from Kureha Corporation and having a melting point of higher than 170° C. and lower than or equal to 175° C.) was used.

In addition, for comparison, the positive electrode 11 was fabricated by a similar procedure except that, as the negative electrode conductor, carbon black not having the hollow structure (acetylene black (AB)) was used in place of the carbon black having the hollow structure.

### (Fabrication of Negative Electrode)

First, 98 parts by weight of the negative electrode active material and 2 parts by weight of the negative electrode binder were mixed with each other to thereby obtain a negative electrode mixture. As the negative electrode active material, artificial graphite and natural graphite serving as the carbon material, and silicon oxide (SiOₓ) serving as the silicon-containing material were used. In a case of using the artificial graphite and the silicon-containing material in combination, a mixture ratio (a weight ratio) between the artificial graphite and the silicon-containing material was set to 80:20. As the negative electrode binder, polyvinylidene difluoride serving as the high-melting-point vinylidene fluoride polymer described above was used.

Thereafter, the negative electrode mixture was put into an organic solvent (N-methyl-2-pyrrolidone), following which the organic solvent was stirred to thereby prepare a paste negative electrode mixture slurry. Thereafter, the negative electrode mixture slurry was applied on each of the two opposed surfaces of the negative electrode current collector 12A (a copper foil having a thickness of 15 μm) by means of a coating apparatus, following which the applied negative electrode mixture slurry was dried to thereby form the negative electrode active material layer 12B.

Lastly, the negative electrode active material layer 12B was compression-molded by means of a roll pressing machine. The negative electrode active material layer 12B was thus disposed on each of the two opposed surfaces of the negative electrode current collector 12A. In this manner, the negative electrode 12 was fabricated.

### (Preparation of Electrolytic Solution)

The electrolyte salt (LiPF₆ which is a lithium salt) was added to a solvent (ethylene carbonate which is a cyclic carbonic acid ester and diethyl carbonate which is a chain carbonic acid ester), following which the solvent was stirred. In this case, a mixture ratio (a weight ratio) between ethylene carbonate and diethyl carbonate in the solvent was set to 30:70, and the content of the electrolyte salt with respect to the solvent was set to 1 mol/kg. The electrolyte salt was thereby dissolved or dispersed in the solvent. In this manner, the electrolytic solution was prepared.

### (Assembly of Secondary Battery)

First, the positive electrode lead 31 including aluminum was welded to the positive electrode 11 (the positive electrode current collector 11A), and the negative electrode lead 32 including copper was welded to the negative electrode 12 (the negative electrode current collector 12A).

Thereafter, the positive electrode 11 and the negative electrode 12 were stacked on each other with the separator 13 (a fine-porous polyethylene film having a thickness of 15 μm) interposed therebetween, following which the stack of the positive electrode 11, the negative electrode 12, and the separator 13 was wound to thereby fabricate the wound body. Thereafter, the wound body was pressed by means of a pressing machine, and was thereby shaped into an elongated shape.

Thereafter, the wound body was placed inside the depression part 20U of the outer package film 20. As the outer package film 20, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order. Thereafter, the outer package film 20 was folded in such a manner as to sandwich the wound body and to have the fusion-bonding layer on the inner side, following which the outer edges of two sides of the outer package film 20 (the fusion-bonding layer) were thermal-fusion-bonded to each other to thereby allow the wound body to be contained inside the pouch-shaped outer package film 20.

Lastly, the electrolytic solution was injected into the pouch-shaped outer package film 20 and thereafter, the outer edges of the remaining one side of the outer package film 20 (the fusion-bonding layer) were thermal-fusion-bonded to each other in a reduced-pressure environment. In this case, the sealing film 21 (a polypropylene film having a thickness of 5 μm) was interposed between the outer package film 20 and the positive electrode lead 31, and the sealing film 22 (a polypropylene film having a thickness of 5 μm) was interposed between the outer package film 20 and the negative electrode lead 32. The wound body was thereby impregnated with the electrolytic solution. Thus, the battery device 10 was fabricated. In this manner, the battery device 10 was sealed in the outer package film 20, and the secondary battery was thus assembled.

### (Stabilization of Secondary Battery)

The secondary battery was charged and discharged for one cycle in an ambient temperature environment (at a temperature of 23° C.). Upon the charging, the secondary battery was charged with a constant current of 0.1 C until a voltage reached 4.2 V, and was thereafter charged with a constant voltage of 4.2 V until a current reached 0.05 C. Upon the discharging, the secondary battery was discharged with a constant current of 0.1 C until the voltage reached 2.5 V. Note that 0.1 C is a value of a current that causes a battery capacity (a theoretical capacity) to be completely discharged in 10 hours, and 0.05 C is a value of a current that causes the battery capacity to be completely discharged in 20 hours.

As a result, a film was formed on, for example, the surface of the negative electrode 12 to stabilize the state of the secondary battery. Thus, the secondary battery of the laminated-film type was completed.

After the completion of the secondary battery, the positive electrode 11 and the separator 13 were collected, following which the separator 13 was peeled from the positive electrode 11. As a result, the positive electrode active material layer 11B remained on the positive electrode current collector 11A without being peeled together with the separator 13. It was thus confirmed that the adhesion strength Si of the positive electrode active material layer 11B to the positive electrode current collector 11A was larger than the adhesion strength S2 of the positive electrode active material layer 11B to the separator 13.

Evaluation of the performance (an energy characteristic and an electric resistance characteristic) of the secondary batteries revealed the results presented in Table 1 and Table 2. A procedure of evaluating each characteristic was as described below.

### (Energy Characteristic)

The secondary battery was charged and discharged in an ambient temperature environment to thereby measure a discharge capacity (a battery capacity (mAh)) of the secondary battery. Charging and discharging conditions were similar to those in stabilizing the secondary battery described above.

### (Electric Resistance Characteristic)

First, the secondary battery was charged in an ambient temperature environment. Charging and discharging conditions were similar to those in stabilizing the secondary battery described above. Thereafter, the secondary battery was discharged with a constant current of 0.1 C for 5 hours to thereby adjust a depth of charge of the secondary battery to 50%. Thereafter, immediately after the depth of charge was adjusted to be 50%, the secondary battery was discharged with a constant current of 1.0 C for 1 second to thereby measure an amount of voltage change ΔV between before and after the discharging with the constant current. Note that 1.0 C is a value of a current that causes the battery capacity to be completely discharged in 1 hour. Lastly, a direct-current resistance of the secondary battery was measured on the basis of a calculation formula: direct-current resistance (mΩ)=amount of voltage change ΔV/current value (=1.0 C).

TABLE 1

| | | | | | | | | | | Negative | | |
|---|---|---|---|---|---|---|---|---|---|---|---|---|
| | Positive electrode | | | | | | | | | electrode | | |
| | Positive | Ratio | | Ratio | | Ratio | | Element | Heating | Negative | | Direct- |
| | electrode | R1 | Positive | R2 | Positive | R3 | Volume | concen- | temper- | electrode | Battery | current |
| Experiment | active | (wt | electrode | (wt | electrode | (wt | density | tration | ature | active | capacity | resistance |
| example | material | %) | binder | %) | conductor | %) | (g/cm³) | (%) | (° C.) | material | (mAh) | (mΩ) |
| 1 | LCO | 98.7 | LM | 0.6 | KB | 0.7 | 4.10 | 1.7 | 100 | Artificial | 2520 | 82 |
| 2 | | 98.5 | PVDF | 0.8 | | | 4.15 | 1.9 | | graphite | 2550 | 75 |
| 3 | | 98.4 | | 0.9 | | | 4.15 | 1.9 | | | 2545 | 76 |
| 4 | | 98.3 | | 1.0 | | | 4.15 | 2.0 | | | 2540 | 76 |
| 5 | | 98.2 | | 1.1 | | | 4.15 | 2.0 | | | 2540 | 77 |
| 6 | | 98.1 | | 1.2 | | | 4.15 | 2.5 | | | 2535 | 77 |
| 7 | | 97.9 | | 1.4 | | | 4.20 | 3.0 | | | 2530 | 78 |
| 8 | | 97.7 | | 1.6 | | | 4.15 | 3.2 | | | 2500 | 85 |
| 9 | LCO | 98.7 | LM | 1.0 | KB | 0.3 | 4.10 | 2.0 | 100 | Artificial | 2520 | 85 |
| 10 | | 98.5 | PVDF | | | 0.5 | 4.15 | 2.0 | | graphite | 2550 | 73 |
| 11 | | 98.4 | | | | 0.6 | 4.15 | 2.0 | | | 2540 | 74 |
| 12 | | 98.3 | | | | 0.7 | 4.15 | 2.0 | | | 2540 | 74 |
| 13 | | 98.2 | | | | 0.8 | 4.15 | 2.0 | | | 2540 | 75 |
| 14 | | 98.1 | | | | 0.9 | 4.15 | 2.0 | | | 2530 | 76 |
| 15 | | 97.9 | | | | 1.1 | 4.20 | 2.0 | | | 2530 | 76 |
| 16 | | 97.7 | | | | 1.3 | 4.15 | 2.0 | | | 2500 | 74 |

TABLE 2

| | | | | | | | | | | Negative | | |
|---|---|---|---|---|---|---|---|---|---|---|---|---|
| | Positive electrode | | | | | | | | | electrode | | |
| | Positive | Ratio | | Ratio | | Ratio | | Element | Heating | Negative | | Direct- |
| | electrode | R1 | Positive | R2 | Positive | R3 | Volume | concen- | temper- | electrode | Battery | current |
| Experiment | active | (wt | electrode | (wt | electrode | (wt | density | tration | ature | active | capacity | resistance |
| example | material | %) | binder | %) | conductor | %) | (g/cm³) | (%) | (° C.) | material | (mAh) | (mΩ) |
| 17 | LCOA | 98.3 | LM | 1.0 | KB | 0.7 | 4.15 | 2.0 | 100 | Artificial | 2540 | 76 |
| | | | PVDF | | | | | | | graphite | | |
| 18 | LCO | 98.3 | | | | | 4.15 | 2.0 | | Natural | 2540 | 76 |
| | | | | | | | | | | graphite | | |
| 19 | | 98.3 | | | | | 4.15 | 2.0 | | Artificial | 2550 | 76 |
| | | | | | | | | | | graphite + | | |
| | | | | | | | | | | SiOx | | |
| 20 | LCO | 98.7 | HM | 0.6 | KB | 0.7 | 4.00 | 2.0 | 100 | Artificial | 2520 | 82 |
| 21 | | 98.3 | PVDF | 1.0 | | | 4.05 | 3.0 | | graphite | 2540 | 83 |
| 22 | | 97.7 | | 1.6 | | | 4.10 | 5.0 | | | 2500 | 85 |
| 23 | LCO | 98.7 | LM | 1.0 | AB | 0.3 | 4.10 | 2.0 | 100 | Artificial | 2500 | 95 |
| 24 | | 98.3 | PVDF | | | 0.7 | 4.10 | 3.0 | | graphite | 2520 | 85 |
| 25 | | 97.7 | | | | 1.3 | 4.10 | 5.0 | | | 2480 | 82 |

As indicated in Table 1 and Table 2, in the secondary battery in which the positive electrode 11 (the positive electrode active material) includes the lithium-cobalt composite oxide and the negative electrode 12 (the negative electrode active material) includes the carbon material, each of the energy characteristic and the electric resistance characteristic varied depending on the configuration of the positive electrode active material layer 11B (the kind of the positive electrode binder, the kind of the positive electrode conductor, and the ratios R1, R2, and R3).

Specifically, in a case where the positive electrode binder included the high-melting-point vinylidene fluoride polymer (HMPVDF) (Experiment examples 20 to 22) and a case where the positive electrode conductor included the carbon black not having the hollow structure (AB) (Experiment examples 23 to 25), a satisfactory result was not obtained for either the battery capacity or the direct-current resistance, regardless of the ratios R1, R2, and R3. In other words, a sufficient battery capacity was not obtained in most cases, and the direct-current resistance increased across the board.

In contrast, in a case where the positive electrode binder included the low-melting-point vinylidene fluoride polymer (LMPVDF) and the positive electrode conductor included the carbon black having the hollow structure (KB) (Experiment examples 1 to 19), a satisfactory result was obtained for both the battery capacity and the direct-current resistance, depending on the ratios R1, R2, and R3.

More specifically, in a case where three conditions that the ratio R1 is within a range from 97.9 wt % to 98.5 wt % both inclusive, the ratio R2 is within a range from 0.8 wt % to 1.4 wt % both inclusive, and the ratio R3 is within a range from 0.5 wt % to 1.1 wt % both inclusive were satisfied simultaneously (Experiment examples 2 to 7, 10 to 15, and 17 to 19), the battery capacity sufficiently increased and the direct-current resistance sufficiently decreased, unlike in a case where the three conditions were not satisfied simultaneously (Experiment examples 1, 8, 9, and 16).

In particular, in the case where the three conditions were satisfied simultaneously, a series of tendencies described below were obtained.

Firstly, as a result of the ratios R1, R2, and R3 being within the above-described respective ranges, the volume density of the positive electrode active material layer 11B increased to 4.15 g/cm³ or greater, and the element concentration of the fluorine atom decreased to fall within a range from 1.9% to 3.0% both inclusive.

Secondly, also in a case where the kind of the lithium-cobalt composite oxide was changed (Experiment example 17) and a case where the kind of the carbon material was changed (Experiment example 18), the battery capacity sufficiently increased and the direct-current resistance sufficiently decreased.

Thirdly, in a case where the negative electrode active material included the silicon-containing material together with the carbon material (Experiment example 19), the battery capacity further increased, as compared with a case where the negative electrode active material included only the carbon material (Experiment example 4).

### Experiment Example 26

As indicated in Table 3, a secondary battery was fabricated by a similar procedure except that the additive (polyvinylpyrrolidone (PVP)) was added to the positive electrode mixture, and the performance of the secondary battery was evaluated. In this case, an amount of the additive added to the positive electrode mixture was 0.03 wt %.

TABLE 3
Ratio R1 = 98.3 wt %, ratio R2 = 1.0 wt %, ratio R3 = 0.7 wt %

| | | | | | | | | Negative | | |
|---|---|---|---|---|---|---|---|---|---|---|
| | Positive electrode | | | | | | | electrode | | |
| | Positive | | | | | | | Negative | | Direct- |
| | electrode | Positive | Positive | | Volume | Element | Heating | electrode | Battery | current |
| Experiment | active | electrode | electrode | | density | concentration | temperature | active | capacity | resistance |
| example | material | binder | conductor | Additive | (g/cm³) | (%) | (° C.) | material | (mAh) | (mΩ) |
| 4 | LCO | LM | KB | — | 4.15 | 2.0 | 100 | Artificial | 2540 | 76 |
| 26 | | PVDF | | PVP | 4.15 | 2.0 | | graphite | 2545 | 75 |

As indicated in Table 3, in a case where the positive electrode active material layer 11B included the additive (PVP) (Experiment example 26), the battery capacity further increased and the direct-current resistance further decreased, as compared with a case where the positive electrode active material layer 11B did not include the additive (Experiment example 4).

### Experiment Examples 27 and 28

As indicated in Table 4, secondary batteries were fabricated by a similar procedure except that the heating temperature (° C.) of the positive electrode active material layer 11B was changed in the process of fabricating the positive electrode 11 (after the compression molding), and the performance of the secondary batteries was evaluated.

TABLE 4
Ratio R1 = 98.3 wt %, ratio R2 = 1.0 wt %, ratio R3 = 0.7 wt %

| | | | | | | | Negative | | |
|---|---|---|---|---|---|---|---|---|---|
| | Positive electrode | | | | | | electrode | | |
| | Positive | | | | | | Negative | | Direct- |
| | electrode | Positive | Positive | Volume | Element | Heating | electrode | Battery | current |
| Experiment | active | electrode | electrode | density | concentration | temperature | active | capacity | resistance |
| example | material | binder | conductor | (g/cm³) | (%) | (° C.) | material | (mAh) | (mΩ) |
| 4 | LCO | LM | KB | 4.15 | 2.0 | 100 | Artificial | 2540 | 76 |
| 27 | | PVDF | | 4.15 | 3.0 | 150 | graphite | 2535 | 78 |
| 28 | | | | 4.15 | 4.0 | 200 | | 2520 | 85 |

As indicated in Table 4, the element concentration of the fluorine atom changed depending on the heating temperature. In this case, if the heating temperature was 150° C. or less, the element concentration of the fluorine atom decreased to 3.0% or less. Accordingly, the battery capacity sufficiently increased and the direct-current resistance sufficiently decreased.

Based upon the results presented in Table 1 to Table 4, in a case where the positive electrode active material included the lithium-cobalt composite oxide, the positive electrode binder included the low-melting-point vinylidene fluoride polymer, the positive electrode conductor included the carbon black having the hollow structure, and the negative electrode active material included the carbon material, if the ratio R1 of the positive electrode active material was within a range from 97.9 wt % to 98.5 wt % both inclusive, the ratio R2 of the positive electrode binder was within a range from 0.8 wt % to 1.4 wt % both inclusive, the ratio R3 of the positive electrode conductor was within a range from 0.5 wt % to 1.1 wt % both inclusive, and the element concentration of the fluorine atom as measured by the surface analysis of the positive electrode active material layer 11B using the XPS was within a range from 1.9% to 3.0% both inclusive, the volume density of the positive electrode active material layer 11B increased to 4.15 g/cm³ or greater. In addition, the battery capacity sufficiently increased and the direct-current resistance sufficiently decreased. Accordingly, in the secondary battery, it was possible to achieve both improvement of the energy density and reduction of the electric resistance.

Although the present technology has been described herein, the configuration of the present technology is not limited thereto, and is therefore modifiable in a variety of ways.

Although the description has been given of the case where the secondary battery has a battery structure of the laminated-film type, the battery structure is not particularly limited. Specifically, examples of the battery structure may include a cylindrical type, a prismatic type, a coin type, and a button type.

Further, although the description has been given of the case where the battery device has a device structure of the wound type, the device structure of the battery device is not particularly limited. Specifically, examples of the device structure may include a stacked type in which the electrodes (the positive electrode and the negative electrode) are stacked, and a zigzag folded type in which the electrodes (the positive electrode and the negative electrode) are each folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited thereto. Accordingly, the present technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a positive electrode active material layer, the positive electrode active material layer including a positive electrode active material, a positive electrode binder, and a positive electrode conductor;
a negative electrode including a negative electrode active material; and
an electrolytic solution, wherein
the positive electrode active material includes a lithium-cobalt composite oxide,
the positive electrode binder includes a vinylidene fluoride polymer having a melting point of higher than or equal to 160 degrees Celsius and lower than or equal to 170 degrees Celsius,
the positive electrode conductor includes carbon black having a hollow structure,
the negative electrode active material includes a carbon material,
a ratio of a weight of the positive electrode active material to a sum of the weight of the positive electrode active material, a weight of the positive electrode binder, and a weight of the positive electrode conductor is greater than or equal to 97.9 weight percent and less than or equal to 98.5 weight percent,
a ratio of the weight of the positive electrode binder to the sum of the weight of the positive electrode active material, the weight of the positive electrode binder, and the weight of the positive electrode conductor is greater than or equal to 0.8 weight percent and less than or equal to 1.4 weight percent,
a ratio of the weight of the positive electrode conductor to the sum of the weight of the positive electrode active material, the weight of the positive electrode binder, and the weight of the positive electrode conductor is greater than or equal to 0.5 weight percent and less than or equal to 1.1 weight percent,
a volume density of the positive electrode active material layer is 4.15 grams per cubic centimeter or greater, and
an element concentration of a fluorine atom as measured by surface analysis of the positive electrode active material layer using X-ray photoelectron spectroscopy is greater than or equal to 1.9 percent and less than or equal to 3.0 percent.

2. The secondary battery according to claim 1, wherein the lithium-cobalt composite oxide includes a compound represented by Formula (1) below,
LiₓCo_{1-y}M_{y}O_{2-z}X_{z} (1)
where
M is at least one of Ti, V, Cr, Mn, Fe, Ni, Cu, Na, Mg, Al, Si, Sn, K, Ca, Zn, Ga, Sr, Y, Zr, Nb, Mo, Ba, La, W, or B,
X is at least one of F, Cl, Br, I, or S,
x, y, and z satisfy 0.8<x<1.2, 0≤y<0.15, and 0≤z<0.05,
a composition of Li differs depending on a charge and discharge state, and
a value of x is a value in a completely discharged state.

3. The secondary battery according to claim 1, wherein the carbon black having the hollow structure includes Ketjen black.

4. The secondary battery according to claim 1, wherein the carbon material includes artificial graphite, natural graphite, or both.

5. The secondary battery according to claim 1, wherein the negative electrode active material further includes a silicon-containing material.

6. The secondary battery according to claim 1, wherein the positive electrode active material layer further includes polyvinylpyrrolidone.

7. The secondary battery according to claim 1, further comprising a separator interposed between the positive electrode and the negative electrode, wherein
the positive electrode further includes a positive electrode current collector that supports the positive electrode active material layer,
the positive electrode active material layer adheres to each of the positive electrode current collector and the separator, and
an adhesion strength of the positive electrode active material layer to the positive electrode current collector is larger than an adhesion strength of the positive electrode active material layer to the separator.

8. The secondary battery according to claim 1, wherein the secondary battery comprises a lithium-ion secondary battery.
